(19) United States
(12) Patent Application Publication
(10) Pub. No.: US 2021/0134290 A1
(43) Pub. Date: May 6, 2021

(54) VOICE-DRIVEN NAVIGATION OF DYNAMIC AUDIO FILES

(71) Applicant: The Seelig Group LLC, New York, NY (US)

(72) Inventors: Andrew Kraftsow, Sedona, AZ (US); Rohith Rao, Brooklyn, NY (US)

(21) Appl. No.: 17/085,198

(22) Filed: Oct. 30, 2020

Related U.S. Application Data
(60) Provisional application No. 62/927,836, filed on Oct. 30, 2019.

(51) Int. Cl. G10L 15/22; G10L 15/06

(52) U.S. Cl. CPC G10L 15/22; G10L 15/06

(57) ABSTRACT

A system for investigating, organizing, connecting and accumulating user feedback on dynamic libraries consisting primarily, but not exclusively, of audio files.

### CROSS REFERENCE TO RELATED APPLICATIONS

This application claims benefit of U.S. Provisional Application No. 62/927,836, filed Oct. 30, 2019, the contents of which are incorporated herein by reference.

### BACKGROUND OF THE INVENTION

### 1. Field of the Invention

The present invention relates to systems and methods for investigating, organizing, connecting and accumulating user feedback on dynamic libraries consisting primarily, but not exclusively, of audio files.

### 2. Introduction

The use of audio files is ubiquitous over global networks for a multitude of purposes. For example, a nascent industry of podcasting (the creation and dissemination of audio files for download) is exploding as a preferred form of content consumption. The business community has also entered the podcasting market. For example, a company can create a series of discrete, but related, audio files (e.g., podcasts) that users may download and listen to at their leisure. The convenience, ease, and low cost of podcasting has enabled anyone who wants to enter the podcast market to do so.

However, once a podcast (or many forms of audio files) is distributed, not much can be done to enable a user to browse the material according to the user's wants and needs. A user simply has to listen from beginning to end or fast forward or back up through parts of the file to find desired information. Other technology enables tagging portions of the audio file after distributed, but it is generally limited to a timestamp with little relation to the actual content at the timestamp. Similarly, before distribution the creator of a podcast may insert their own “signposts” for the convenience of users. For example, audio files may be split into “chapters,” like in a book, and tagged appropriately. But after distribution, finding or connecting with content not previously identified and/or tagged is difficult. Thus, control of such audio is usually limited to control of metadata associated with the audio file, or characteristics of playback.

With the advent of voice recognition technology, e.g., Apple Siri or Amazon Alexa, it has become possible to speak commands that control audio files. For example, a voice command can be issued to play an audio file, or move forward/backward a certain duration (e.g., 90 seconds) within the file. Other methods include utilizing tagging to create “signposts” for the file that can be used by voice command to navigate through a particular file. For example, pre-determined tags can be created to indicate chapters in an audiobook file or organize audio files into groupings. When a voice command such as “go to chapter X” is issued, the audio file begins its play at the appropriate chapter.

However, this method of navigation is also limited to data that is external to the audio file. In other words, the content of the file is not examined in a voice command search, the metadata is. As an example, if a sportscaster in a podcast says that “Player A threw for Y yards,” a voice command issued under the prior art of “Search for Player A” would not find anything until and unless external metadata is associated with the audio file prior to play back. Also, unless a timestamp is also associated with the location of the utterance “Player A,” the voice command will not navigate to the location with the particular file.

Additionally, current systems are unable to collect instantaneous feedback from a user listening to a particular audio file. For example, if someone is listening to a movie review or a song, there are few mechanisms to be able to “have a conversation” with the user about their feedback about the audio file. Current methods may include the ability to click a “heart,” smiley face or the like on a display interface, but such methods cannot accept instantaneous audio feedback from a user, analyze the feedback, and continue the response/feedback process.

What is needed is a system and method to enable dynamically linking audio files that can be navigated via voice as well as providing a mechanism for users to provide feedback that can be analyzed and reported upon to the providers of the audio files.

### SUMMARY OF THE INVENTION

While the way in which the present invention addresses the disadvantages of the prior art will be discussed in greater detail below, in general, the present invention relates to systems and methods for investigating, organizing, connecting and accumulating user feedback on dynamic libraries consisting primarily, but not exclusively, of audio files. The systems and method provide an environment for a voice driven library navigation (VDLN) system.

FIG. 1 illustrates an exemplary VDLN system 100. The VDLN system includes an Assistant, a command system, a library identification system, a linking system, a user response and feedback system, and a storage system.

The Assistant facilitates voice recognition and speaking for the VDLN and serves as the user interface for the VDLN system. The VDLN system includes a command system configured to receive input from the Assistant and issues various commands to the VDLN system. The library identification system includes a search sub-system that determines any additional files or libraries (e.g., a set of files with a common attribute) to add to the operating library before any other operations are conducted. The VDLN system includes a linking system that enables linking multiple audio files together in a cohesive manner so that they may be easily navigated the user. Moreover, the synonym expansion system may be used to identify terminus points for linking where the exact landing spot is unknown. The VDLN system includes a storage system that comprises any hardware and/or software suitably configured to collect, store, and manage data, files, libraries, and user information for use in the system. The VDLN system includes a user response and feedback system (URFS) configured to receive unstructured audio from a user (e.g., utterances), process and analyze these utterances, and provide feedback to a variety of stakeholders that includes the user and/or the creator/distributer of the audio files.

Additional features and advantages of the invention will be set forth in the description which follows, and in part will be obvious from the description, or may be learned by practice of the invention. The features and advantages of the invention may be realized and obtained by means of the instruments and combinations particularly pointed out in the description. These and other features of the present invention will become more fully apparent from the following description or may be learned by the practice of the invention.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof, which are illustrated in the appended drawings. It should be understood that these drawings depict only typical embodiments of the invention and therefore, should not be considered to be limiting of its scope. The invention will be described and explained with additional specificity and detail through the use of the accompanying drawings in which:

FIG. 1 illustrates an exemplary voice-driven library navigation (VDLN) system.

FIG. 2 illustrates a smart search function of the system.

FIG. 3 illustrates a navigation function of the system.

FIG. 4 illustrates a highlight command of the system.

FIG. 5 illustrates a show me command of the system.

FIG. 6 illustrates an E-commerce function of the system.

FIG. 7 illustrates an open-ended response of the system.

FIG. 8 illustrates an exemplary process of the system.

### DETAILED DESCRIPTION OF THE INVENTION

Various exemplary embodiments of the invention are described in detail below. While specific implementations involving electronic devices (e.g., computers, phones, smart speakers, microphone-enabled headphones) are described, it should be understood that the description here is merely illustrative and not intended to limit the scope of the various aspects of the invention. A person skilled in the relevant art will recognize that other components and configurations may be easily used or substituted for those that are described here without parting from the spirit and scope of the invention.

The present invention facilitates investigating, organizing, connecting and accumulating user feedback on dynamic libraries consisting primarily, but not exclusively, of audio files. In particular, the invention provides a system that includes an electronic assistant, a command system, a library identification system, a linking system, a user response and feedback system, and a storage system. Files used within the system may include a variety of file formats, information, and/or data. A non-limiting list of content and file formats include articles, text, word processing, spreadsheet, or presentation documents, Portable Document Files, visual media such as pictures, video, and the like. File formats include .doc (Microsoft Word), .xls (Microsoft Excel), .ppt (Microsoft Powerpoint), .pdf, EPub, .rtf (Rich Text Form), .bmp, .jpg, .jpeg, .gif, .png, .tiff, .msg, .eml, .mp3, .mp4, .m4v and the like. Audio files, emails, web pages, Internet bookmarks, and text messages are included in the type of content that may be utilized. The term “audio files” as used in this document includes the content and/or file formats listed above unless otherwise indicated. Moreover, the term “content author” or “author” as used in this document includes the actual author of the content, or an owner, distributor, or provider, whether authored or provided by a human or machine.

For the sake of brevity, conventional data networking, application development and other functional aspects of the systems (and components of the individual operating components of the systems) may not be described in detail. The connecting lines shown in the various figures are intended to represent exemplary functional relationships and/or physical couplings between various elements. It should be noted that many alternative or additional functional relationships or physical connections may be present in a practical system.

The invention may be described in terms of functional block components, optional selections and various processing steps. It should be appreciated that such functional blocks may be realized by any number of hardware and/or software components configured to perform the specified functions. For example, the invention may employ various integrated circuit components, e.g., memory elements, processing elements, logic elements, audio and/or visual elements, input/output elements, wired or wireless communication techniques, and the like, which may carry out a variety of functions under the control of one or more microprocessors or other control devices. Additionally, the components and/or devices may employ voice-activated technology to perform various functions of the invention.

Similarly, the software elements of the invention may be implemented with any programming, scripting language or web service protocols such as C, C++, C#, Java, COBOL, assembler, and the like. As those skilled in the art will appreciate, the software and hardware elements may be implemented with an operating system such as Microsoft Windows®, Microsoft Mobile, UNIX, Apple OS X, MacOS, Apple iOS, Android, Linux, and the like. Software elements may also include utilizing the services of a cloud-based platform or software as a service (SaaS) to deliver functionality to the various system components.

As will be appreciated by one of ordinary skill in the art, the system may be embodied as a customization of an existing system, an add-on product, upgraded software, a stand-alone system, a distributed system, a method, a data processing system, a device for data processing, and/or a computer program product. Accordingly, the system may take the form of an entirely software embodiment, an entirely hardware embodiment, or an embodiment combining aspects of both software and hardware. Furthermore, the system may take the form of a computer program product on a computer-readable storage medium having computer-readable program code means embodied in the storage medium. Any suitable computer-readable storage medium may be utilized, including hard disks, CD-ROM, DVDs, optical storage devices, magnetic storage devices, solid state storage devices and/or the like.

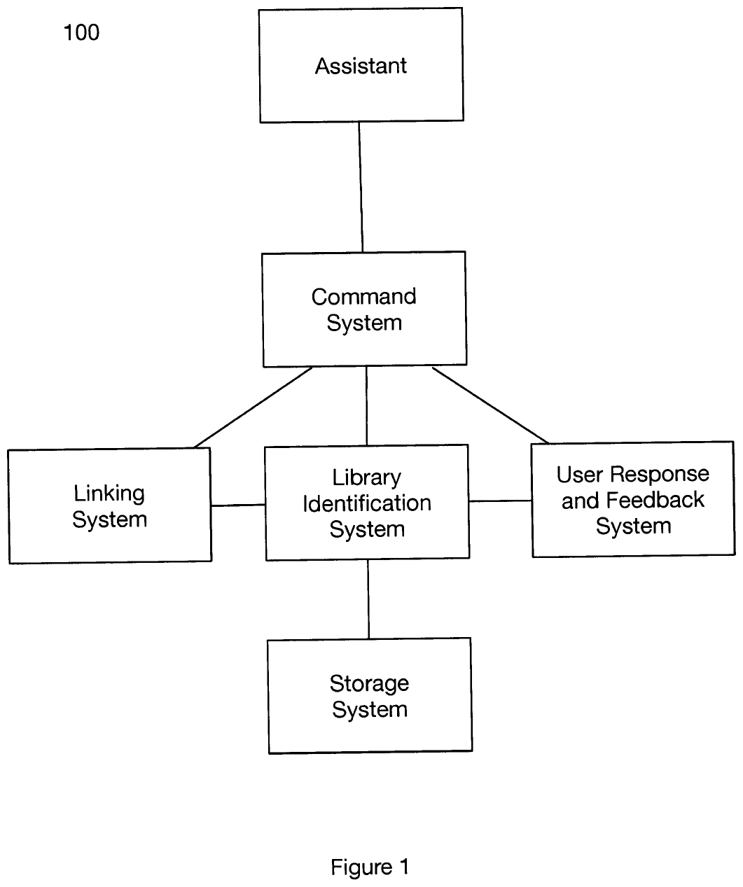

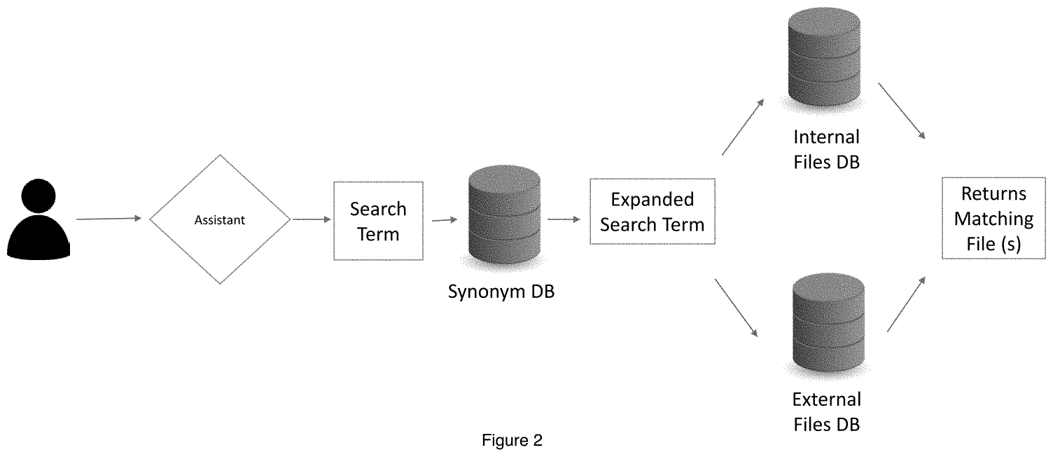

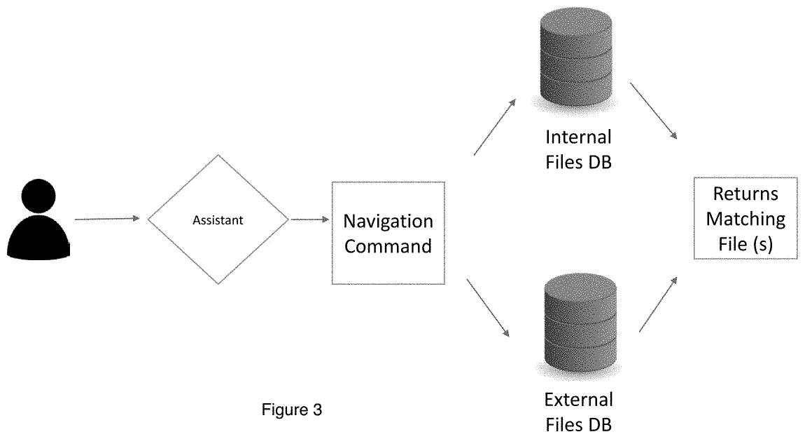

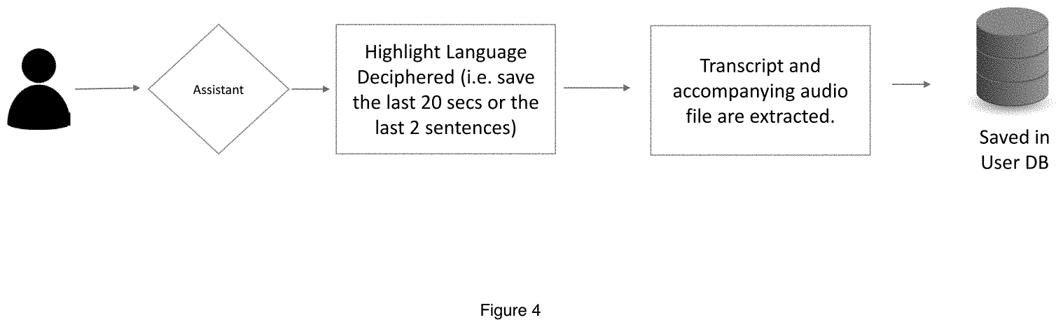

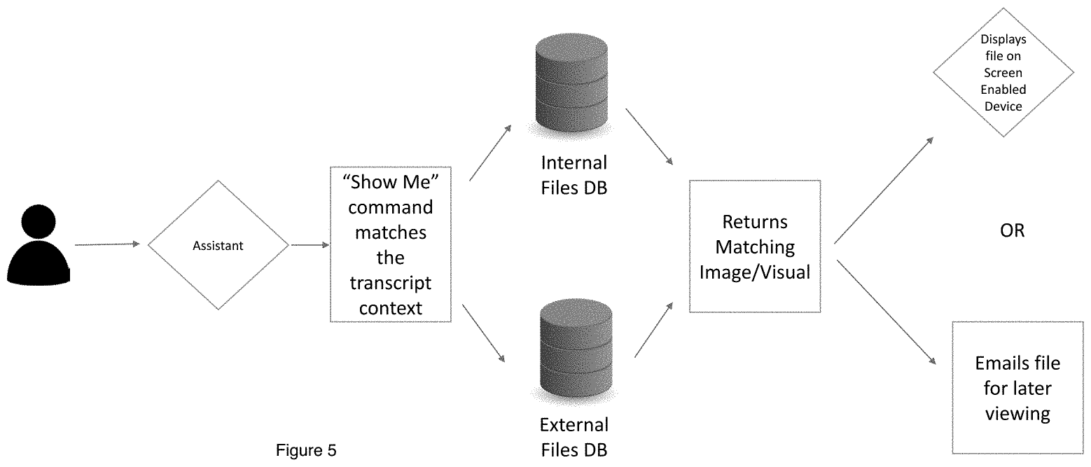

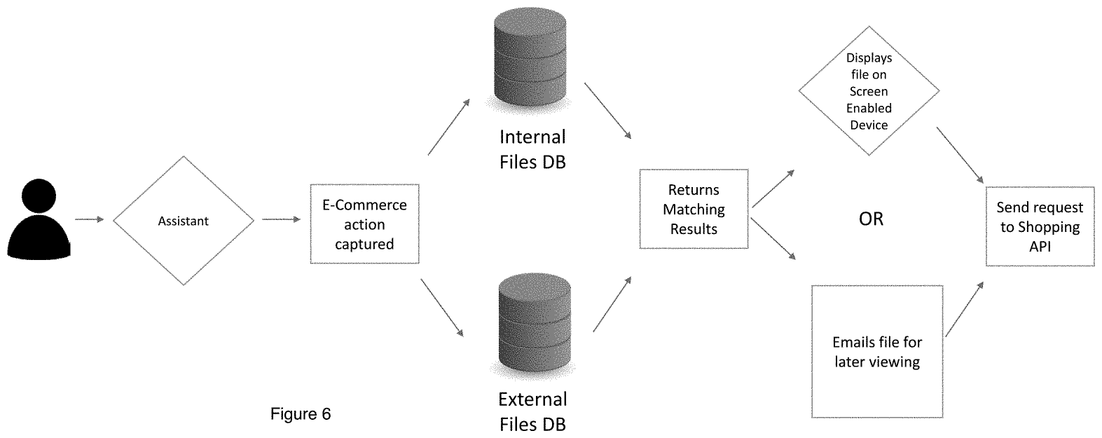

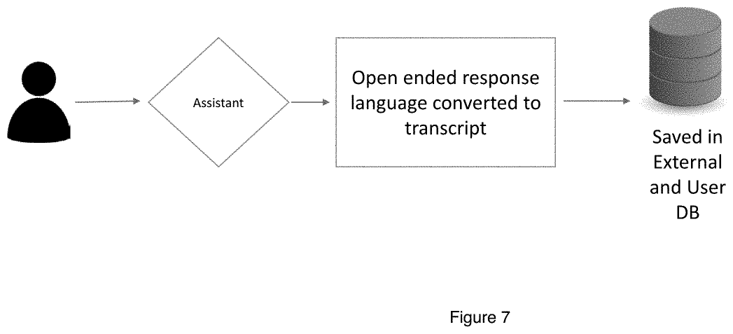

FIG. 1 illustrates an exemplary voice-driven library navigation (VDLN) system 100. The VDLN system includes an Assistant, a command system, a library identification system, a linking system, a user response and feedback system, and a storage system. FIG. 2 illustrates how a user initiates a smart search command using an Assistant that is configured to expand a search term using the Synonym Database to find relevant files. FIG. 3 illustrates how a user initiates a navigation command using the Assistant. FIG. 4 illustrates how a highlight command is initiated by the user to “highlight” or save a portion of language in an audio file. FIG. 5 illustrates how a user initiates a show me command that returns an image or visual that matches a part of the transcript. FIG. 6 illustrates how a user initiates an e-commerce transaction through the Assistant where results matching voice utterances are either displayed or emailed for viewing and possibly purchase. FIG. 7 illustrates how an utterance is converted to a transcript and saved for later use by the system.

The Assistant facilitates voice recognition and speaking for the VDLN and serves as the user interface for the VDLN system. Typically, the Assistant is a combination of hardware and software (e.g., a handheld phone or smart speaker) configured to receive voice and/or other type of input from a user, perform voice recognition tasks, and execute software tasks to accomplish various functions of the VDLN system. The Assistant may contain the complete VDLN system explained herein or facilitate and perform parts of VDLN functionality. To perform its functions, the VDLN may operate as part of a distributed computing environment that may include handheld devices (e.g., an iPhone or Android phone), cloud computing services, and other devices remote to the Assistant. In an exemplary embodiment, the Assistant is a “smart speaker,” e.g., Amazon Alexa. In another exemplary embodiment, the Assistant is Google Assistant available on a variety of devices.

### Command System

The VDLN system includes a command system configured to receive input from the Assistant and issues various commands to the VDLN system. The command system supports at least two categories of commands, machine-centric commands and library-specific commands. Machine-centric commands are commands (whether voice-recognized or not) that may be used throughout the VDLN system to direct behavior of the overall system. For example, commands such as “play louder,” “stop,” “resume,” are commands that control the device, such as a handheld phone.

Library specific commands are those commands that are used during an audio playback. For example, “jump to the word ‘shoe’,” or “go to the first chapter,” are commands that enable one to navigate the audio file(s). Such commands may be used to navigate within a specific audio file or may be used to navigate between linked audio files within a library (which will be explained further below).

### Library Identification System

A Library is a set of audio files that the VDLN system will interact with, termed the operating library. Upon initial use, an operating library is created and/or accessed. The operating library may contain one or more audio files that are related, not related, or both. The operating library is dynamic in that files may be added or deleted from the operating library depending on the operation. For example, the system may begin with a known operating library, for example, a set of podcasts selected by the system or user. However, the user may perform a search which results in additional podcasts added to the operating library that were not previously identified by the system. Conversely, a search may be conducted that limits the operating library in subsequent operations, e.g., a search within the operating library that limits the results to ten results. Through the use of the command system, a user may dynamically build and/or navigate the libraries.

The library identification system includes a search sub-system that determines any additional files or libraries (i.e., a set of files with a common attribute) to add to the operating library before any other operations are conducted. First, audio files in the search results are converted to text so that further operations may be performed on the files. Once converted, the process may include various algorithms to include or discard certain search results. Unlike written search results that may appear as a readable list on a device, for example, a web page, or a list on a display for a phone, longer lists of spoken results are difficult for a user to remember. Based on the desired application, the library identification system will only return a subset of files for further operation. For example, the operation may only return the top three results of a search. As another example, a particular operation may require ordering the results, for example, by frequency or other type of measures. Once the search has been conducted according to the desired algorithm, the search results are dynamically tagged with search terms and made available for further operations.

The library identification system optionally includes a synonym expansion sub-system that may be employed to enable the expansion of a search based on synonyms or fuzzy searching. Various known methods for synonym expansion or fuzzy searching may be used that are suitable to the desired application.

### Storage System

The VDLN system includes a storage system that comprises any hardware and/or software suitably configured to collect, store, and manage data, files, libraries, and user information for use in the system. In general, the storage system is implemented as a combination of hardware and application software configured to store, upload, download, or delete content. In an exemplary embodiment, the storage system includes a synonym database, an internal files database, an external files database, and a user database.

The Synonym Database stores data to enable the functionality to expand user searches using synonym rings based on search terms, for example, as described in the search sub-system and synonym expansion sub-system.

The Internal Files Database stores audio files that relate to a particular library that a user is interacting within the system. For example, if a user submits a query related to a brand of shoes, the internal files database will contain other audio files relevant to the brand of the shoe. Relatedly, the External Files Database stores audio files from a source that is “external” to the instant user interaction. For example, in the branded shoe query above, the external files database will store information regarding branded shoes from other brands that were not queried.

The User Database stores a history of user interactions, timestamp information, and other user information (e.g., name, email, etc.) collected by the Assistant or other parts of the system.

The type of content that may be uploaded is unlimited. However, typical content to upload are audio files. Other content such as emails, web pages, Internet bookmarks, text messages, articles, text, word processing, spreadsheet, or presentation documents, Portable Document Files, visual media such as pictures, video, and the like are included in the type of content that may be utilized. The file formats include articles, text, word processing, spreadsheet, or presentation documents, Portable Document Files, visual media such as pictures, video, and the like. File formats include .doc (Microsoft Word), .xls (Microsoft Excel), .ppt (Microsoft Powerpoint), .pdf, EPub, .rtf (Rich Text Form), .bmp, .jpg, .jpeg, .gif, .png, .tiff, .msg, .eml, .mp3, .mp4, .m4v and the like.

The VDLN system includes a Tracking System configured to track a user's “path” through various files in a given session. Voice commands are captured as a user speaks to the system at particular points within a particular audio file. If the audio file contains a branch, the voice command is captured. Some voice commands are not available at all points in the file or throughout the system. If an utterance is captured at a pre-determined location in an audio file for which the command is available, the voice command that corresponds to the utterance is identified and processed. For example, if a user is listening to a podcast and issues a command in the middle of the podcast to “tell me more about X,” a query will be issued, and a result will be returned regarding the “tell me more” command. In this example, it may be another podcast that starts playing regarding the subject X. As that podcast is playing, the user may issue yet another similar command that returns yet another podcast. When the user no longer wants to listen to the third podcast, the user may issue a command such as “return me to the second podcast,” which will return the user to the point where the user issued the “third podcast” command. Alternatively, the user may issue the command “return me back to the first podcast,” and the user will be returned to the departure point in the first podcast directly from the third podcast.

The VDLN system is also configured to enable a user to tag portions of audio files, including specific words within the audio files. Such tags may be used later in search and navigation. For example, a user may issue a command “pause and tag these words” while listening to a podcast. The system will perform the tagging function and continue with the podcast.

### Linking System

The VDLN system includes a linking system that enables linking multiple audio files together in a cohesive manner so that they may be easily navigated by the user. Moreover, the synonym expansion system may be used to identify terminus points for linking where the exact landing spot is unknown. Audio files related to a particular audio file may be linked according to a variety of attributes. Multiple link points may be identified in an audio file. The link points are then associated with other content such as audio files and/or locations within linked audio files. A cue is placed at the linking point within the first audio file, for example, a short audio tone, that alerts the user to the existence of a “link” to other related content. The user may then issue a command to the system to navigate to the second linked file. The user may return to the first file by speaking an appropriate command, for example, “return,” to cause the system to navigate to the first audio file link point. As an example, an author may have various audio files related to a particular field, such as health and nutrition. A user may be listening to a first audio file regarding nutritional needs of a running athlete. However, the author may also have created audio files related to health concerns of running. The author may create a link point in the first file that will alert the user at the appropriate location that there is a second audio file available on a related subject. The linking system will keep track of the path a user takes through the various link points so that a user can explore various audio files without losing their place in the original audio file.

### User Response and Feedback System

The VDLN system includes a user response and feedback system (URFS) configured to receive unstructured utterances from a user, process and analyze the utterances, and provide feedback to a variety of stakeholders. As a user navigates libraries and files, the user may speak utterances that are not necessarily commands but opinions on the content. For example, the audio file may be a movie review. As the user is listening to the review, the user may state an opinion about the movie, the actors in the movie, the subject, etc. The system will determine that such utterances are not commands and provide such utterances to the user response and feedback system. For example, the system utilizes synonym expansion of the utterance and uses the results (termed an “expanded utterance”) to perform a search, e.g., a fuzzy search and/or Boolean search, to determine if the expanded utterance matches a command in the existing system. If a command is matched, e.g., move forward 5 minutes, it is processed accordingly. However, if the expanded utterance does not match a command, the utterance is interpreted as feedback. For example, if the utterance was that the speaker did not like the movie, the user response and feedback system will receive the utterance, perhaps tag it for further analysis, or prompt the user with an additional question(s). In some embodiments, the URFS may prompt the user with further questions based on previous utterances. Continuing with the above example, the systems may prompt the user with “why did you not like the movie?” or “is there any other information you would like to provide?” The system may continue to analyze such utterances depending on the particular implementation (e.g., the system may be directed to only ask three follow-up questions). In some implementations, the system will end the feedback session and provide the user with navigation commands for the user to continue. In some implementations, the feedback from the session can be analyzed and a report is created for further analysis. By utilizing the URFS, a content author/distributor and the like may affect a “conversation” with the user based on closed and open-ended questions. By combining such feedback from a large group of users, a content author can use the information to tailor future content, modify marketing plans, or in a variety of different ways.

In embodiments involving a feedback session, the system may stop the playback of the current audio file and conduct a feedback session, and then return the user to the playback of the first audio file. A feedback session may comprise any number of questions or statements responsive to the user depending on the application. In some embodiments, once a feedback session is initiated, the user may not be able to use some or all navigation commands (e.g., to ensure the session is completed). In other embodiments, the session's navigation is similar to the current navigation commands in the current audio file. Feedback session may be initiated based on a variety of factors particular to the application. In some embodiments, initiation of a session may be time-based (e.g., # of minutes a user has been listening). In other embodiments, initiation of a session may occur upon recognition of a particular utterance or set of utterances. In yet other embodiments, the initiation of a session may occur only if a particular audio file or set of files have already been listened to or accessed in some way by the user. For example, a session may only be initiated if a particular user has listened to a health-related audio file and a shoe-related audio file. In some embodiments, a feedback session may incorporate multiple speakers in response to a single audio file being played. For example, an audio file may be played to a room having multiple people listening to the file. A feedback session may then be initiated at a particular point within the audio file. Feedback may be received, recorded and/or analyzed from multiple people in response to the audio file. In some embodiments, the session may record multiple feedback utterances and process them one at a time in sequence. As an example, a group may be presented with an audio file about a public figure. At a particular point, feedback may be solicited (e.g., a series of questions or statements to react to). Multiple people may respond. The system may record the feedback and then initiate a question to one or more of the responses within the feedback received. For example, the system may state “someone or many people stated that they did not like the public figure, can one person describe why they do not like the figure?” After a user responds, the system may move another feedback utterance, such as “now, some of you stated you did like the public figure, can one person describe why?” Feedback sessions may be conducted in a variety of ways and are not limited to the embodiments described above.

Depending on the physical configuration, these systems may use a variety of methods to communicate with each other. For example, in some embodiments, the systems, or portions thereof, may communicate over one or more networks using protocols suited to the particular system and communication. As used herein, the term “network” shall include any electronic communications means which incorporates both hardware and software components. Communication among the systems may be accomplished through any suitable communication channels, such as, for example, a telephone network, an extranet, an intranet, Internet, portable computer device, personal digital assistant, online communications, satellite communications, off-line communications, wireless communications, transponder communications, local area network, wide area network, networked or linked devices, keyboard, mouse and/or any suitable communication or data input modality. In some embodiments, the storage, sharing, and recommendation system may share hardware and software components. In other exemplary embodiments, each system is contained within a single physical unit and appropriately coupled through various integrated circuit components.

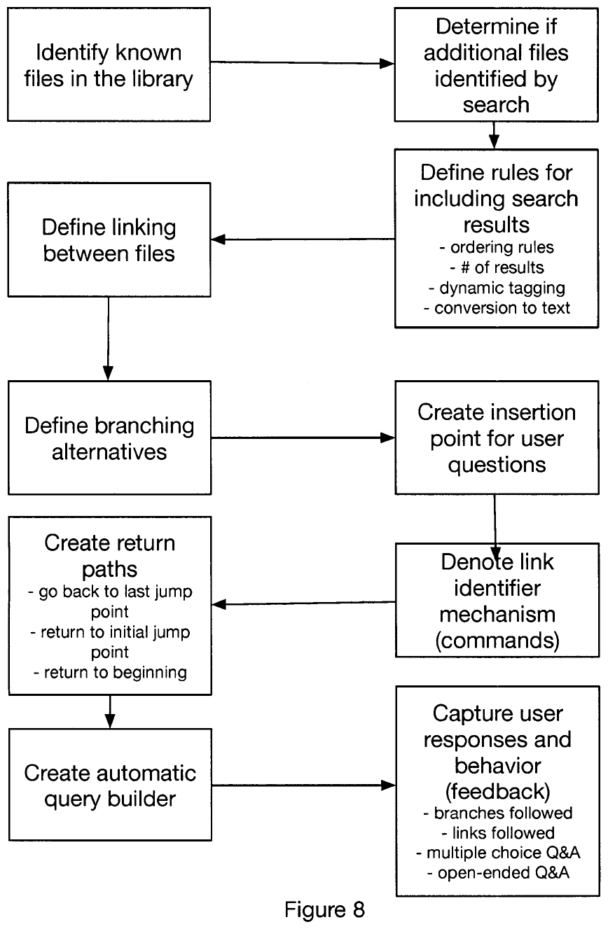

FIG. 8 illustrates an exemplary process for use of the system. The process may be used in a variety of situations, such as making a podcast interactive, converting live shows into interactive podcasts, or organizing libraries of audio files for further use, e.g., litigation. First, the process identifies known files in a particular library. Next, a determination is made for searching for additional files according to one or more criteria. Once the particular files/libraries have been identified, links may be created between the files for navigation, including identifying branching alternatives. Once linking/branching has been determined, locations within the various files are determined to illicit feedback from users. Next, the commands needed to enable navigation through the files are determined (e.g., “go to chapter 1,” or “move forward 5 minutes”). Once the linking has been determined, the ability to create and track various return paths from a particular start location is created. In this example, three return paths are enabled: (1) a user may go back to the last time they navigated from a particular point; (2) a user may return to a first jump point in the first audio file; and (3) a user may return to the beginning of a session. Optionally, a voice activated query builder may be employed so that a user may issue non-predetermined queries to the system. For example, a user listening to a health audio file interested in hydration may ask for information by asking “I am interested in staying hydrated during a run.” The system may expand the query using, for example, synonym expansion and context analysis to including “drinking water” or “drinking sports drinks” but not “drinking beer.” Lastly, user responses/feedback, either prompted or not, may be recorded, which may include how many branches or links the user followed, answers to questions with discrete answers, and recording answers to open-ended questions.

The above description is meant to illustrate some of the features of the invention. Other configurations of the described embodiments of the invention are part of the scope and spirit of this invention.

1. A voice driven audio navigation system comprising:
an assistant system configured to receive utterances from a user;
a command system configured to receive a recognized utterance from the assistant system and translate the recognized utterance into a command, the command causing the system to perform an appropriate task using one or more of the following systems:
a library identification system configured to receive a command, search one or more libraries and create a subset of audio files related to the search;
a storage system configured to store audio files, commands, search results, queries, and user data in response to a command;
a linking system configured to create one or more links between audio files and/or libraries within the subset of audio files related to the search;
a user response and feedback system configured to capture recognized user utterances that are not commands, record feedback from the user, and analyze the utterances.

2. The system of claim 1, wherein the assistant is a handheld phone.

3. The system of claim 1, wherein the assistant is a smart speaker.

4. The system of claim 1, wherein the library identification system searches the one or more libraries using synonym expansion.

5. The system of claim 1, wherein the user response and feedback system prompts the user with an additional question after analysis of the recognized user utterances.

6. A method for organizing and connecting audio files comprising the steps of:
identifying one or more audio files in a library;
determining whether additional audio files should be added to the library based on one or more criteria;
linking one or more of the audio files in the library with navigation and branching alternatives;
inserting feedback identifiers at one or more locations within the audio files in the library;
determining navigation commands appropriate to navigating the audio files in the library via voice; and
creating one or more return paths within the audio files in the library.

7. The method in claim 6 further comprising the steps of:
creating additional terms for navigating the audio files in the library based on synonym expansion a user's utterance.

8. The method in claim 6 further comprising the steps of:
initiating a feedback session by halting play of one or more of the audio files in the library;
issuing a request for feedback from the user; and
recording the user's utterances in response to the request for feedback.
